(19) United States
(12) Patent Application Publication
(10) Pub. No.: US 2023/0262183 A1
(43) Pub. Date: Aug. 17, 2023

(54) SHEET DETECTING APPARATUS, IMAGE PROCESSING APPARATUS, AND SIGNAL ADJUSTING METHOD

(71) Applicant: KYOCERA Document Solutions Inc., Osaka-shi (JP)

(72) Inventors: Ryo KAWAOKA, Osaka-shi (JP); Tadaharu KUSUMI, Osaka-shi (JP)

(21) Appl. No.: 18/101,665

(22) Filed: Jan. 26, 2023

(30) Foreign Application Priority Data
Jan. 28, 2022 (JP) 2022-011540

(51) Int. Cl. H04N 1/00; H04N 1/028

(52) U.S. Cl. CPC H04N 1/00819; H04N 1/02865

(57) ABSTRACT

A sheet detecting apparatus includes: a light emitting unit that emits light emitted toward a detection position; a light receiving unit that is provided to receive the light reflected by a sheet present at the detection position and that outputs an electric signal which corresponds to a received light amount; and an adjustment processing unit that adjusts, within a specified range, a duty ratio of a drive pulse signal used to drive the light emitting unit, so that a detection value of the electric signal output from the light receiving unit is included in a specified standard range; and a decision processing unit that decides the specified range based on a change range which is among a variable range of the duty ratio of the drive pulse signal and in which the detection value of the electric signal changes in response to a change in the duty ratio.

### INCORPORATION BY REFERENCE

This application is based upon, and claims the benefit of priority from, corresponding Japanese Patent Application No. 2022-011540 filed in the Japan Patent Office on Jan. 28, 2022, the entire contents of which are incorporated herein by reference.

### BACKGROUND

### Field of the Invention

This disclosure relates to a sheet detecting apparatus, an image processing apparatus, and a signal adjusting method.

### Description of Related Art

An image processing apparatus such as multifunction machine is equipped with a reflective light sensor that is used for detecting a sheet of a document and the like. The light sensor has a light emitting unit and a light receiving unit.

In the light sensor, the light emitting characteristic of the light emitting unit and the light receiving characteristic of the light receiving unit, as the case may be, vary from one individual to another. The light emitting characteristic of the light emitting unit and the light receiving characteristic of the light receiving unit, as the case may be, vary due to a change in an environmental temperature and the like. In this respect, as a related technology, there is known an image processing apparatus capable of adjusting the frequency or duty ratio of a drive pulse signal, which is used for driving the light emitting unit, so that a detection value of an electric signal which is output from the light receiving unit when a sheet is detected is included in a specified range.

### SUMMARY

A sheet detecting apparatus according to an aspect of the present disclosure includes: a light emitting unit; a light receiving unit; an adjustment processing unit; and a decision processing unit. The light emitting unit emits light emitted toward a detection position. The light receiving unit is provided to be capable of receiving the light reflected by a sheet present at the detection position and outputs an electric signal which corresponds to a received light amount. The adjustment processing unit adjusts, within a specified range, a duty ratio of a drive pulse signal used to drive the light emitting unit, so that a detection value of the electric signal output from the light receiving unit is included in a specified standard range. The decision processing unit decides the specified range based on a change range which is among a variable range of the duty ratio of the drive pulse signal and in which the detection value of the electric signal changes in response to a change in the duty ratio.

An image processing apparatus according to another aspect of the present disclosure includes: the sheet detecting apparatus; and an image reading unit. The image reading unit reads an image of the sheet detected by the sheet detecting apparatus.

A signal adjusting method according to another aspect of the present disclosure is executed by a sheet detecting apparatus including a light emitting unit that emits light emitted toward a detection position, and a light receiving unit that is provided to be capable of receiving the light reflected by a sheet present at the detection position and that outputs an electric signal which corresponds to a received light amount, and the signal adjusting method includes: an adjusting step; and a deciding step. The adjusting step adjusts, within a specified range, a duty ratio of a drive pulse signal used to drive the light emitting unit, so that a detection value of the electric signal output from the light receiving unit is included in a specified standard range. The deciding step decides the specified range based on a change range which is among a variable range of the duty ratio of the drive pulse signal and in which the detection value of the electric signal changes in response to a change in the duty ratio.

### BRIEF DESCRIPTION OF THE DRAWINGS

FIG. 1 is a diagram showing a configuration of an image forming apparatus according to an embodiment of the present disclosure.

FIG. 2 is a block diagram showing a system configuration of the image forming apparatus according to the embodiment of the present disclosure.

FIG. 3 is a diagram showing a configuration of a sheet detecting apparatus according to the embodiment of the present disclosure.

FIG. 4 is a flowchart showing an example of change range determining process executed by the image forming apparatus according to the embodiment of the present disclosure.

FIG. 5 is a flowchart showing an example of a signal adjusting process executed in the image forming apparatus according to the embodiment of the present disclosure.

FIG. 6 shows a graph that is based on correspondence data acquired by the image forming apparatus of the present disclosure.

### DETAILED DESCRIPTION

A description will hereinafter be made on an embodiment of the present disclosure with reference to the accompanying drawings. It should be noted that the following embodiment is an example embodying this disclosure, and does not limit the technical scope of this disclosure.

[Configuration of Image Forming Apparatus 100]

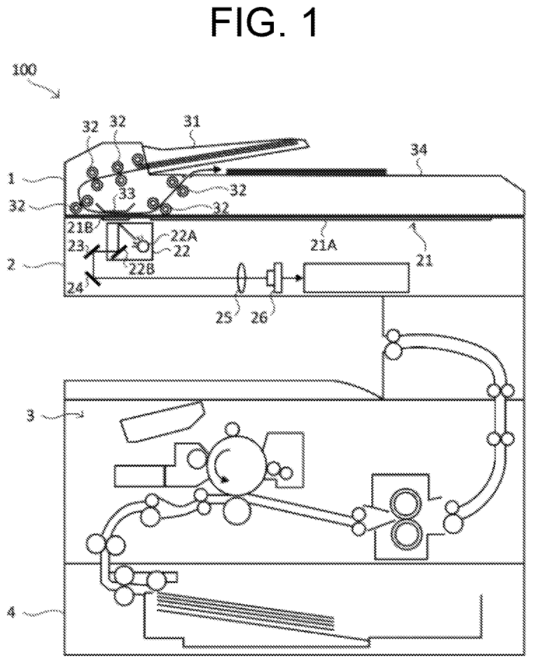

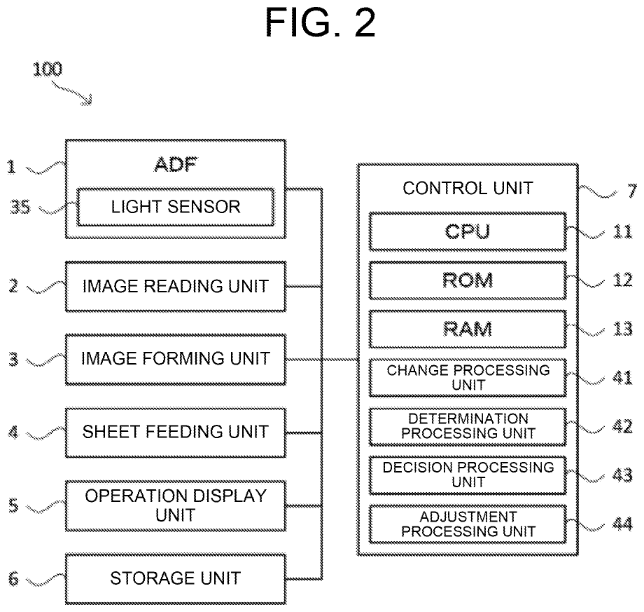

First, with reference to FIG. 1 and FIG. 2, a description is made on a configuration of an image forming apparatus 100 according to an embodiment of this disclosure. Here, FIG. 1 is a cross-sectional view showing the configuration of the image forming apparatus 100.

The image forming apparatus 100 is a multifunction peripheral having a plurality of functions such as scanning function for reading an image of a document, printing function for forming the image based on image data, faxing function, and copying function. The image forming apparatus 100 is an example of the image processing apparatus of this disclosure. Further, this disclosure may be applied to an image processing apparatus such as scanner, printer, fax machine, and copier.

As shown in FIGS. 1 and 2, the image forming apparatus 100 is equipped with an ADF (Auto Document Feeder) 1, an image reading unit 2, an image forming unit 3, a sheet feeding unit 4, an operation display unit 5, a storage unit 6, and a control unit 7.

The ADF 1 conveys the document to be read by the above scanning function.

The image reading unit 2 executes the scanning function.

The image forming unit 3 realizes the printing function. Specifically, the image forming unit 3 forms the image by an electrophotographic method. Specifically, the image forming unit 3 includes a photosensitive drum, a charging apparatus, a laser scanning unit (LSU), a developing apparatus, a transferring apparatus, a cleaning apparatus, and a fixing apparatus.

The sheet feeding unit 4 feeds a sheet to the image forming unit 3. The sheet feeding unit 4 is equipped with a sheet cassette and a plurality of conveying rollers.

The operation display unit 5 is a user interface of the image forming apparatus 100. The operation display unit 5 has a display unit, such as liquid crystal display, which displays various types of information in accordance with a control instruction from the control unit 7, and an operation unit, such as operation key or touch screen, which inputs various types of information to the control unit 7 in accordance with the user's operation.

The storage unit 6 is a non-volatile storage medium. For example, the storage unit 6 is a non-volatile memory such as flash memory and EEPROM (registered trademark), SSD (Solid State Drive), or a storage apparatus such as HDD (Hard Disk Drive).

The control unit 7 comprehensively controls the image forming apparatus 100. As shown in FIG. 2, the control unit 7 has a CPU 11, a ROM 12, and a RAM 13. The CPU 11 is a processor that executes various types of arithmetic processes. The ROM 12 is a nonvolatile storage apparatus in which information such as control program for the CPU 11 to execute the various types of processing is preliminarily stored. The RAM 13 is a volatile or nonvolatile storage apparatus that is used as a temporary storage memory (working area) for the various processes executed by the CPU 11. The CPU 11 executes various types of control programs preliminarily stored in the ROM 12. In this way, the CPU 11 comprehensively controls the image forming apparatus 100.

[Configurations of ADF 1 and Image Reading Unit 2]

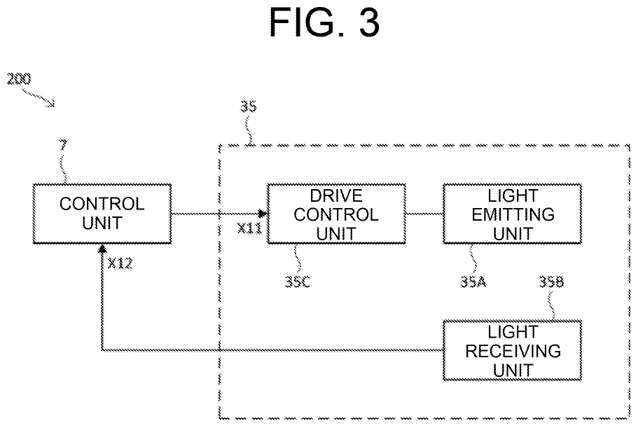

Next, with reference to FIG. 1 to FIG. 3, a description is given of configurations of the ADF 1 and image reading unit 2. The arrow line in FIG. 3 shows a drive pulse signal X11 output from the control unit 7 and an electric signal X12 input to the control unit 7.

As shown in FIG. 1, the image reading unit 2 is equipped with a document stand 21, a reading unit 22, a mirror 23, a mirror 24, an optical lens 25, and a CCD 26.

The document stand 21 is provided at the upper portion of a box-like housing that houses each component element of the image reading unit 2. As shown in FIG. 1, the document stand 21 includes a first contact glass 21A and a second contact glass 21B. The first contact glass 21A is a glass plate formed flat, and has an upper face on which the document is placed. The second contact glass 21B transmits light emitted from the reading unit 22 toward the document conveyed by the ADF 1.

The ADF 1 is so mounted as to be openable and closable relative to the first contact glass 21A. In this way, the ADF 1 functions as a document cover for the document placed on the first contact glass 21A.

The reading unit 22 is provided below the first contact glass 21A and the second contact glass 21B. The reading unit 22 is configured to be movable in a sub-scanning direction (right/left directions on the sheet in FIG. 1) by a moving mechanism (not shown) having a drive unit such as stepping motor. As shown in FIG. 1, the reading unit 22 has a light source 22A and a mirror 22B.

The light source 22A includes plural LEDs arrayed along the main scanning direction (sheet depth direction in FIG. 1) which is orthogonal to the sub-scanning direction. Toward the first contact glass 21A or the second contact glass 21B, the light source 22A emits light for one line in the main scanning direction. The light emitted from the light source 22A passes through the first contact glass 21A or the second contact glass 21B, and illuminates the document placed on the first contact glass 21A or the document conveyed by the ADF 1. To the mirror 23, the mirror 22B reflects the light emitted from the light source 22A and reflected by the document.

In the image reading unit 2; when the image data is read from the document placed on the first contact glass 21A, the reading unit 22 is moved along the sub-scanning direction. As a result, the light irradiated from light source 22A to the document is scanned along the sub-scanning direction. In the image reading unit 2; when the image data is read from the document conveyed by the ADF 1, the reading unit 22 is positioned below the second contact glass 21B. As a result, the light emitted from the light source 22A passes through the second contact glass 21B, and illuminates the document conveyed by the ADF 1.

To the mirror 24, the mirror 23 reflects the light reflected by the mirror 22B of the reading unit 22. To the optical lens 25, the mirror 24 reflects the light reflected by the mirror 23. The optical lens 25 converges the light reflected by the mirror 24 and causes the converged light to enter the CCD 26.

The CCD 26 is an image sensor having a plurality of photoelectric conversion elements arrayed along the main scanning direction. The CCD 26 outputs an electric signal that corresponds to a received light amount. In the image reading unit 2, the light emitted from the light source 22A and reflected by the document is incident on the CCD 26 via the mirror 22B, the mirror 23, the mirror 24, and the optical lens 25. With this, an analog electric signal that corresponds to the image of the document is output from the CCD 26. The analog electric signal output from the CCD 26 is converted to a digital electric signal (image data) by an AFE (analog front end) (not shown) circuit, and is input to the control unit 7.

As shown in FIG. 1, the ADF 1 includes a document placing unit 31, a plurality of conveying rollers 32, a document guide 33, and a sheet ejecting unit 34. As shown in FIGS. 2 and 3, the ADF 1 is equipped with a light sensor 35.

The document whose image is scanned by the image reading unit 2 is placed on the document placing unit 31. The document placed on the document placing unit 31 is conveyed to a conveying path formed inside the housing of the ADF 1.

The plural conveying rollers 32 convey, to the sheet ejecting unit 34 via a reading position of reading an image data by the image reading unit 2, the document conveyed on the conveying path conveying roller.

To the reading position, the document guide 33 guides the document conveyed by the conveying roller 32.

To the sheet ejecting unit 34, the document that passed through the reading position is ejected.

The light sensor 35 detects the document placed on the document placing unit 31. The light sensor 35 is a so-called reflective light sensor. As shown in FIG. 3, the light sensor 35 has a light emitting unit 35A, a light receiving unit 35B, and a drive control unit 35C.

The light emitting unit 35A is a light emitting element, such as light emitting diode, that emits light that is emitted toward a specific detection position. Specifically, the detection position is a specific position on a document placing face of the document placing unit 31. The light emitting unit 35A is provided on the lower side of the document placing face.

The light receiving unit 35B is a light receiving element, such as phototransistor, which is so provided as to be capable of receiving the light emitted from the light emitting unit 35A and reflected by the document present at the detection position, and outputs the electric signal X12 (see FIG. 3) that corresponds to the received light amount. The light receiving unit 35B is provided on the lower side of the document placing face. The electric signal X12 output from the light receiving unit 35B is input to the control unit 7.

The drive control unit 35C controls the driving of the light emitting unit 35A based on a drive pulse signal X11 (see FIG. 3) input from the control unit 7. For example, the drive control unit 35C includes a power supply and a transistor. The power supply feeds power to the light emitting unit 35A. The transistor is provided in a power feeding path between the power supply and the light emitting unit 35A, and switches the conductivity and cutoff of the power feeding path based on the drive pulse signal X11.

The control unit 7, based on a detection value of the electric signal X12 output from the light receiving unit 35B, determines whether or not the document is present at the detection position. For example, the control unit 7, when the detection value of the electric signal X12 output from the light receiving unit 35B is within a specific detection range, determines that the document is present at the detection position. The control unit 7, when the detection value of the electric signal X12 output from the light receiving unit 35B is outside the detection range, determines that the document is not present at the detection position. For example, the detection value of the electric signal X12 is a voltage value.

The control unit 7 and the light sensor 35 constitute a sheet detecting apparatus 200 (see FIG. 3) that detects the document (an example of the sheet in this disclosure) placed on the document placing unit 31.

Further, the ADF 1 may be equipped with plural light sensors 35 that have, on the document placing face, detection positions different from each other. In this case, the control unit 7, by using of the light sensors 35, may detect the size of the document placed on the document placing unit 31.

By the way, in the light sensor 35, a light emitting characteristic of the light emitting unit 35A and a light emitting characteristic of the light receiving unit 35B may vary from one individual to another. The light emitting characteristic of the light emitting unit 35A and the light emitting characteristic of the light receiving unit 35B may vary due to an environmental temperature's change, an aging deterioration, and the like. In this respect, as a related technology, there is known an image processing apparatus capable of adjusting the frequency or duty ratio of the drive pulse signal X11 so that the detection value of the electric signal X12 which is output from the light receiving unit 35B when the sheet is detected is included in the specified range.

However, in the image processing apparatus according to the related technology, the adjustment range of the frequency or duty ratio of the drive pulse signal X11 is not limited. Due to this, the adjustment time of the drive pulse signal X11, as the case may be, is prolonged.

In contrast, the image forming apparatus 100 according to the embodiment of the present disclosure makes it possible to suppress the prolonged adjustment time of the drive pulse signal X11, as described below.

[Configuration of Control Unit 7]

Next, the configuration of the control unit 7 will be described with reference to FIG. 2.

As shown in FIG. 2, the control unit 7 includes a change processing unit 41, a determination processing unit 42, a decision processing unit 43, and the adjustment processing unit 44.

Specifically, the ROM 12 of the control unit 7 preliminarily stores a signal adjusting program for causing the CPU 11 of the control unit 7 to function as each of the units. And, the CPU 11 of the control unit 7 executes the signal adjusting program stored in the ROM 12, thereby to function as the change processing unit 41, the determination processing unit 42, the decision processing unit 43, and the adjustment processing unit 44.

The signal adjusting program is stored in a computer-readable recording medium such as CD, DVD, and flash memory, and may be read from the recording medium to be stored in a recording apparatus such as the storage unit 6. Further, the change processing unit 41, the determination processing unit 42, the decision processing unit 43, and the adjustment processing unit 44 each may be composed of an electronic circuit such as integrated circuit (ASIC, DSP).

The change processing unit 41 gradually changes a set value of the drive pulse signal X11 within a variable range of the set value.

Specifically, the set value is the frequency of the drive pulse signal X11.

For example, during the drive pulse signal X11's being input to the drive control unit 35C, the change processing unit 41 gradually increases the frequency of the drive pulse signal X11 from the lower limit value to the upper limit value in the variable range of the frequency. Each time a specific unit time elapses, the change processing unit 41 increases the frequency of the drive pulse signal X11 by a specific unit amount, for example. Further, the change processing unit 41 increases the frequency of the drive pulse signal X11 to the upper limit value in the variable range of the frequency.

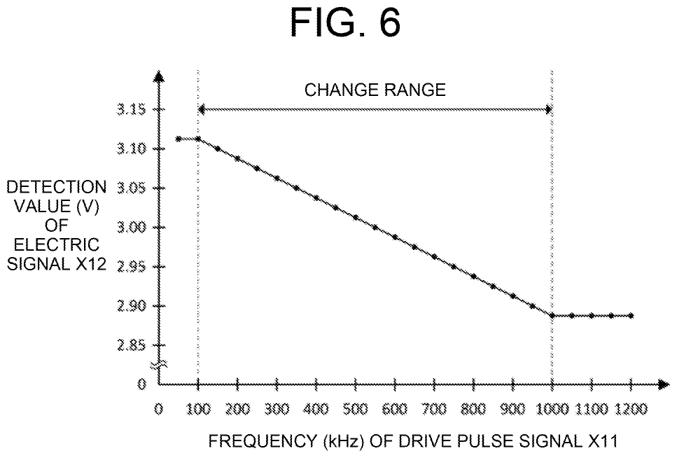

For example, the lower limit value of the variable range of the frequency of the drive pulse signal X11 is 50 kHz (kilohertz) (see FIG. 6). The upper limit value of the variable range of the frequency of the drive pulse signal X11 is 1200 kHz (kilohertz) (see FIG. 6). Further, the unit amount is 50 kHz (kilohertz) (see FIG. 6).

Further, during the drive pulse signal X11's being input to the drive control unit 35C, the change processing unit 41 may gradually decrease the frequency of the drive pulse signal X11 from the upper limit value to the lower limit value in the variable range of the frequency.

Based on the detection value of the electric signal X12 output from the light receiving unit 35B during the set value's changing by the change processing unit 41, the determination processing unit 42 determines the change range which is among the variable range of the set value and in which the detection value of the electric signal X12 changes in response to the change in the set value.

Each time the frequency of the drive pulse signal X11 is changed by the change processing unit 41, for example, the determination processing unit 42 acquires the detection value of the electric signal X12 that corresponds to the frequency after the changing. This acquires correspondence data (see FIG. 6) that shows the correspondence between the frequency of the drive pulse signal X11 input to the light sensor 35 and the detection value of the electric signal X12 output from the light sensor 35. FIG. 6 shows a graph created based on the correspondence data.

Then, the determination processing unit 42 determines the change range, based on the acquired correspondence data. For example, when the correspondence data shown in FIG. 6 is acquired, the determination processing unit 42 determines the range from 100 kHz (kilohertz) to 1000 kHz (kilohertz), where the detection value changes according to the change in frequency, to be the change range.

For example, when determining the change range, the determination processing unit 42 stores change range information, which shows the determined change range, in a specific storage area in the storage unit 6.

The adjustment processing unit 44 adjusts, within a specified range, the set value of the drive pulse signal X11, so that the detection value of the electric signal X12 output from the light receiving unit 35B is included in a specified standard range.

For example, the standard range is a range included in the detection range used for determining the document's detecting by the control unit 7.

For example, during the drive pulse signal X11's being input to the drive control unit 35C, the adjustment processing unit 44 gradually increases the frequency of the drive pulse signal X11 from the lower limit value to the upper limit value in the specified range. The adjustment processing unit 44 increases the frequency of the drive pulse signal X11 by the unit amount, for example, each time the unit time elapses.

Further, each time the frequency of the drive pulse signal X11 changes, the adjustment processing unit 44 acquires the detection value of the electric signal X12 that corresponds to the frequency after the change, thereby to determine whether or not the acquired detection value is included in the standard range.

When the adjustment processing unit 44 determines that the detection value of the acquired electric signal X12 is included in the standard range, the adjustment of the frequency of the drive pulse signal X11 is ended. When determining that the detection value of the acquired electric signal X12 is not included in the standard range, the adjustment processing unit 44 continues to adjust the frequency of the drive pulse signal X11.

When determining that the detection value of the acquired electric signal X12 is not included in the standard range, the adjustment processing unit 44 may change the frequency of the drive pulse signal X11 by a change amount that corresponds to the difference between the detection value and the standard range.

Further, during the drive pulse signal X11's being input to the drive control unit 35C, the adjustment processing unit 44 may gradually decrease the frequency of the drive pulse signal X11 from the upper limit value to the lower limit value in the specified range.

The decision processing unit 43 decides the specified range, based on the change range.

Specifically, the decision processing unit 43 decides the specified range, based on the change range determined by the determination processing unit 42.

For example, the decision processing unit 43 decides, as the specified range, the change range determined by the determination processing unit 42.

The decision processing unit 43 may decide, as the specified range, the range in which either one or both of the lower and upper limit sides of the change range are elongated or shortened by a specific amount.

For example, the decision processing unit 43 may decide, as the specified range, the range in which the lower limit side of the change range is elongated by the specific amount. For example, the specific amount may be an amount that increases as an elapsed time from the previous determination of the change range is longer. Further, the specific amount may be an amount that is decided based on an air temperature at the place where the image forming apparatus 100 is placed. Further, the specific amount may be a pre-determined amount that cannot be changed.

The control unit 7 does not have to include the change processing unit 41 and the determination processing unit 42. In this case, the specific storage area may preliminarily store the change range information.

[Change Range Determining Process]

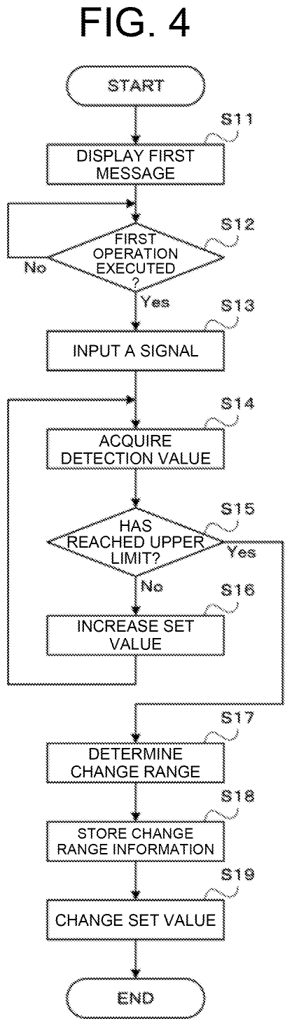

Hereinafter, an example of a procedure of a change range determining process executed by the control unit 7 in the image forming apparatus 100 will be described with reference to FIG. 4. Here, steps S11, S12, . . . represent numbers of the processing procedures (steps) executed by the control unit 7. For example, the change range determining process is executed when an instruction to execute the change range determining process is input by the user's operation on the operation display unit 5.

<Step S11>

First, in step S11, the control unit 7 displays a specific first message on the operation display unit 5.

Here, the first message is a message that urges the user to place the document on the document placing unit 31 and execute a specific first operation.

<Step S12>

In step S12, the control unit 7 determines whether or not the first operation has been executed.

Here, when determining that the first operation has been executed (Yes side in S12), the control unit 7 moves the process to step S13. If the first operation has not been executed (No side of S12), the control unit 7, in step S12, waits for the first operation to be executed.

<Step S13>

In step S13, the control unit 7 sets the set value of the drive pulse signal X11 to the lower limit value in the variable range of the set value, and inputs the drive pulse signal X11 to the drive control unit 35C.

Specifically, the control unit 7 sets the frequency of the drive pulse signal X11 to the lower limit value in the variable range of the frequency, and inputs the drive pulse signal X11 to the drive control unit 35C.

<Step S14>

In step S14, the control unit 7 acquires the detection value of the electric signal X12 output from the light receiving unit 35B that corresponds to the set value which is current.

Specifically, the control unit 7 acquires the detection value of the electric signal X12 that corresponds to the frequency of the drive pulse signal X11 which is current.

<Step S15>

In step S15, the control unit 7 determines whether or not the set value which is current has reached the upper limit value in the variable range of the set value.

Specifically, the control unit 7 determines whether or not the frequency of the drive pulse signal X11 which is current has reached the upper limit value in the variable range of the frequency.

Here, when determining that the set value which is current has reached the upper limit value in the variable range of the set value (Yes side of S15), the control unit 7 moves the process to step S17. If the set value which is current has not reached the upper limit value in the variable range of the set value (No side of S15), the control unit 7 moves the process to step S16.

<Step S16>

In step S16, the control unit 7 increases the set value during the drive pulse signal X11's being input to the drive control unit 35C. Here, the processes in steps S13, S15, and S16 are executed by the change processing unit 41 of the control unit 7.

Specifically, the control unit 7 increases the frequency of the drive pulse signal X11 by the unit amount. Further, the process in step S16 is executed at the timing when the unit time has elapsed from the process in step S13 or from the process in the previous step S16.

In the change range determining process, the processes in step S16 and step S14 are repeatedly executed until it is determined in step S15 that the set value which is current has reached the upper limit value in the variable range of the set value. This is how the correspondence data (see FIG. 6) are acquired.

<Step S17>

In step S17, the control unit 7 determines the change range, based on the acquired correspondence data. Here, the processes in steps S14 and S17 are executed by the determination processing unit 42 of the control unit 7.

<Step S18>

In step S18, the control unit 7, in the specific storage area in the storage unit 6, stores the change range information showing the change range determined by the process in step S17.

If the change range information which is old is stored in the specific storage area, it is sufficient that the change range information which is newly acquired should be stored in place of the change range information which is old.

<Step S19>

In step S19, the control unit 7 changes the set value to the value before the executing of the change range determining process.

Specifically, the control unit 7 changes the frequency of the drive pulse signal X11 to the value before the executing of the change range determining process.

When the ADF 1 is equipped with plural light sensors 35, it is sufficient that the change range determining process should be executed for each of the light sensors 35. In this case, it is sufficient that the specific storage area should be provided for each of the light sensors 35.

[Signal Adjusting Process]

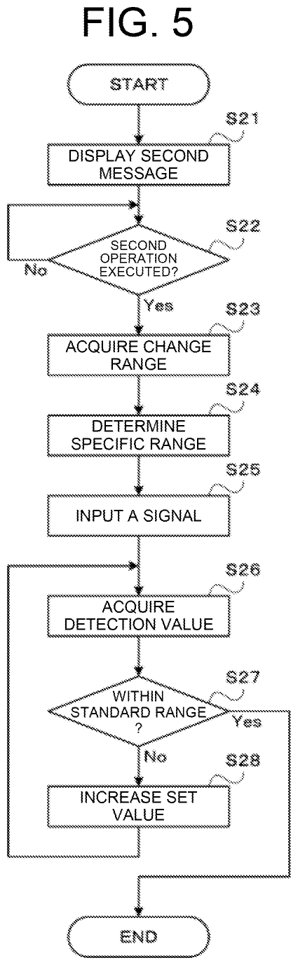

Hereinafter, with reference to FIG. 5, a description is given of an example of a procedure of the signal adjusting process executed by the control unit 7 in the image forming apparatus 100, and given of a signal adjusting method of the present disclosure. For example, the signal adjusting process is executed when an instruction to execute the signal adjusting process is input by the user's operation on the operation display unit 5. The signal adjusting process may be executed in place of the process in step S19 of the change range determining process.

<Step S21>

First, in step S21, the control unit 7 displays a specific second message on the operation display unit 5.

Here, the second message is a message that urges the user to place the document on the document placing unit 31 and execute a specific second operation.

<Step S22>

In step S22, the control unit 7 determines whether or not the second operation has been executed.

Here, when determining that the second operation has been executed (Yes side in S22), the control unit 7 moves the process to step S23. If the second operation has not been executed (No side of S22), the control unit 7, in step S22, waits for the second operation to be executed.

<Step S23>

In step S23, the control unit 7 acquires the change range.

Specifically, the control unit 7 acquires the change range information from the specific storage area in the storage unit 6.

<Step S24>

In step S24, the control unit 7 decides the specified range, based on the change range acquired in step S23. Here, the process in the step S24 is an example of a deciding step of the present disclosure, and is executed by the decision processing unit 43 of the control unit 7.

Specifically, the control unit 7 decides, as the specified range, the change range acquired in step S23.

<Step S25>

In step S25, the control unit 7 sets the set value of the drive pulse signal X11 to the lower limit value in the specified range decided in step S24, and inputs the drive pulse signal X11 to the drive control unit 35C.

Specifically, the control unit 7 sets the frequency of the drive pulse signal X11 to the lower limit value in the specified range, and inputs the drive pulse signal X11 to the drive control unit 35C.

<Step S26>

In step S26, the control unit 7 acquires the detection value of the electric signal X12 output from the light receiving unit 35B.

<Step S27>

In step S27, the control unit 7 determines whether or not the detection value of the electric signal X12 acquired in step S26 is included in the standard range.

Here, when determining that the detection value of the electric signal X12 acquired in step S26 is included in the standard range (Yes side of S27), the control unit 7 ends the signal adjusting process. When determining that the detection value of the electric signal X12 acquired in step S26 is not included in the standard range (No side of S27), the control unit 7 moves the process to step S28.

<Step S28>

In step S28, the control unit 7 increases the set value during the drive pulse signal X11's being input to the drive control unit 35C. Here, the processes from step S25 to step S28 are an example of the adjusting step of the present disclosure, and is executed by the adjustment processing unit 44 of the control unit 7.

Specifically, the control unit 7 increases the frequency of the drive pulse signal X11 by the unit amount. The process in step S28 is executed at the timing when the unit time has elapsed from the process in step S25 or the process in the previous step S28.

In the signal adjusting process, the processes in step S28 and step S26 are repeatedly executed until the detection value of the electric signal X12 is determined, in step S27, to be included in the standard range. This so adjusts the set value that the detection value of the electric signal X12 output from the light receiving unit 35B is included in the standard range. When, before the detection value of the electric signal X12 being determined, in step S27, to be included in the standard range, the set value has reached the upper limit value in the specified range decided in step S24, it is sufficient to report the occurrence of an error and end the signal adjusting process.

When the ADF 1 is equipped with plural light sensors 35, it is sufficient that the signal adjusting process should be executed for each of the light sensors 35.

Thus, in the image forming apparatus 100, the specified range, i.e., the adjustable range of the set value, is decided based on the change range which is among the variable range of the set value of the drive pulse signal X11, and in which the detection value of the electric signal X12 changes in response to a change in the set value. This makes it possible to exclude, from the adjustment range of the set value, the range in which the detection value of the electric signal X12 does not change in response to the change in the set value. Thus, compared to the configuration in which the adjustment range of the set value is not limited, it is possible to suppress the prolonged adjustment time of the drive pulse signal X11.

### Other Embodiment

The set value may be the duty ratio of the drive pulse signal X11.

In this case, it is sufficient that the change processing unit 41 should gradually change the duty ratio of the drive pulse signal X11 within the variable range of the duty ratio. It is sufficient that the change processing unit 41 should gradually change the duty ratio of the drive pulse signal X11 from 100 percent to 0 percent, for example.

It is sufficient that, based on the detection value of the electric signal X12 output from the light receiving unit 35B during the changing, by the change processing unit 41, in duty ratio of the drive pulse signal X11, the determination processing unit 42 should determine the change range which is among the variable range of the duty ratio and in which the detection value of the electric signal X12 changes in response to the change in the duty ratio.

Further, it is sufficient that the decision processing unit 43 should decide the specified range, based on the change range which is among the variable range of the duty ratio of the drive pulse signal X11 and in which the detection value of the electric signal X12 changes in response to change in the duty ratio. Specifically, it is sufficient that the decision processing unit 43 should decide the specified range, based on the change range determined by the determination processing unit 42.

Further, it is sufficient that the adjustment processing unit 44 should adjust the duty ratio of the drive pulse signal X11 within the specified range so that the detection value of the electric signal X12 output from the light receiving unit 35B is included in the standard range. For example, it is sufficient that, by gradually changing the duty ratio of the drive pulse signal X11 from the upper limit value to the lower limit value of the specified range, the adjustment processing unit 44 should adjust the duty ratio.

Further, the sheet detecting apparatus 200 may be used for detecting the sheet on which the image is formed by the image forming unit 3. For example, the sheet detecting apparatus 200 may be used for detecting the sheet housed in the paper feeding cassette or the sheet conveyed by the sheet feeding unit 4.

What is claimed is:

1. A sheet detecting apparatus comprising:
a light emitting unit that emits light emitted toward a detection position;
a light receiving unit that is provided to be capable of receiving the light reflected by a sheet present at the detection position and that outputs an electric signal which corresponds to a received light amount;
an adjustment processing unit that adjusts, within a specified range, a duty ratio of a drive pulse signal used to drive the light emitting unit, so that a detection value of the electric signal output from the light receiving unit is included in a specified standard range; and
a decision processing unit that decides the specified range based on a change range which is among a variable range of the duty ratio of the drive pulse signal and in which the detection value of the electric signal changes in response to a change in the duty ratio.

2. The sheet detecting apparatus according to claim 1, comprising:
a change processing unit that gradually changes the duty ratio of the drive pulse signal within the variable range; and
a determination processing unit that determines the change range, based on the detection value of the electric signal output from the light receiving unit during the changing, by the change processing unit, in the duty ratio of the drive pulse signal, and
the decision processing unit decides the specified range based on the change range determined by the determination processing unit.

3. An image processing apparatus comprising:
the sheet detecting apparatus as claimed in claim 1; and
an image reading unit that reads an image of the sheet detected by the sheet detecting apparatus.

4. A signal adjusting method executed by a sheet detecting apparatus including a light emitting unit that emits light emitted toward a detection position, and a light receiving unit that is provided to be capable of receiving the light reflected by a sheet present at the detection position and that outputs an electric signal which corresponds to a received light amount, the signal adjusting method comprising:
adjusting, within a specified range, a duty ratio of a drive pulse signal used to drive the light emitting unit, so that a detection value of the electric signal output from the light receiving unit is included in a specified standard range; and
deciding the specified range based on a change range which is among a variable range of the duty ratio of the drive pulse signal and in which the detection value of the electric signal changes in response to a change in the duty ratio.
